(19) United States
(12) Patent Application Publication
(10) Pub. No.: US 2024/0402081 A1
(43) Pub. Date: Dec. 5, 2024

(54) MOLECULAR DIFFUSION EVALUATION METHOD AND SYSTEM

(71) Applicant: Nippon Telegraph and Telephone Corporation, Tokyo (JP)

(72) Inventors: Tomomi Murai, Tokyo (JP); Suzuyo Inoue, Tokyo (JP); Aya Tanaka, Tokyo (JP); Riku Takahashi, Tokyo (JP); Michiko Seyama, Tokyo (JP)

(21) Appl. No.: 18/696,856

(22) PCT Filed: Nov. 5, 2021
(86) PCT No.: PCT/JP2021/040751

§ 371 Date: Mar. 28, 2024

(51) Int. Cl. G01N 21/41; G01N 13/00

(52) U.S. Cl. CPC G01N 21/41; G01N 13/00; G01N 2013/003

(57) ABSTRACT

A method includes transporting a solution in which a target molecule is dissolved into a channel including a measurement area by surface plasmon resonance (SPR) and a hydrogel layer provided in the middle of the measurement area to obtain a first measurement result by surface plasmon resonance at a portion where the hydrogel layer is not formed in the measurement area and a second measurement result by surface plasmon resonance at a portion where the hydrogel layer is formed in the measurement area, and evaluating a diffusion rate of the molecules in the hydrogel by comparing the first measurement result with the second measurement result.

### CROSS-REFERENCE TO RELATED APPLICATIONS

This application is a national phase entry of PCT Application No., PCT/JP2021/040751 filed on Nov. 5, 2021, which application is hereby incorporated herein by reference.

### TECHNICAL FIELD

The present invention relates to a molecular diffusion evaluation method and system.

### BACKGROUND

In recent years, research on drug delivery system (DDS) has been actively conducted. DDS is a technology in which a therapeutic agent component is administered to a patient in a state of being wrapped with a material that responds to a change in the external environment, and when reaching a target disease site, the pH or temperature change around the reached portion or light absorption causes an internal drug to be released to the outside of the coating, thereby efficiently delivering the drug to the target site. Since the drug in a state in which the activity is maintained can be released intensively to the target site, advantages such that side effects can be reduced, and a large therapeutic effect is obtained with a small amount of the drug are expected.

In designing a DDS, it is important to select and design a functional material of a coating portion (carrier) capable of controlling release capacity of an internal drug in response to a change in the external environment. As a carrier of DDS, various materials such as a hydrogel, a lipid membrane, a polysaccharide, and a protein have been mainly studied so far. Among them, the hydrogel has a feature that the response performance to external stimuli such as pH and temperature can be easily changed by preparing conditions (type of monomer or crosslinking agent to be a material of gel, chemical modification of monomer, and the like) at the time of making the gel, and research has been actively conducted as a carrier material that easily customizes drug release characteristics.

The drug release capacity of the hydrogel and its rate are greatly affected by diffusion rate of drug molecules in the hydrogel. Therefore, in order to evaluate performance as DDS, a technique of predicting and measuring the diffusion rate of various drug molecules in the hydrogel is required. The hydrogel is composed of a three-dimensional network structure in which a polymer is crosslinked, and has a swollen structure in which a solvent such as water is held in the network structure.

The diffusion rate of the drug is determined by the size of the network of the hydrogel and the interaction between the network and the drug molecule. Although the approximate network size can be estimated, the network size of the hydrogel changes depending on the pH, ion concentration, temperature, and the like around the hydrogel. Therefore, in order to appropriately design a DDS composed of hydrogel, it is essential to measure the diffusion rate of drug molecules under an environment suitable for actual use conditions.

Hitherto, as a method for evaluating the diffusion rate of molecules diffusing in hydrogel, first, there is a fluorescence recovery after photobleaching (FRAP) (Non Patent Literature 1). Second, there is pulsed field gradient nuclear magnetic resonance (PFG-NMR) (Non Patent Literatures 2 and 3). Third, there is a dynamic light scattering measurement (Non Patent Literature 4).

### CITATION LIST

### Non Patent Literature

Non Patent Literature 1: Tom K. L. Meyvis et al., “Fluorescence Recovery After Photobleaching: A Versatile Tool for Mobility and Interaction Measurements in Pharmaceutical Research”, Pharmaceutical Research, vol. 16, no. 8, pp. 1153-1162, 1999.
Non Patent Literature 2: WILLIAM S. PRICE, “Pulsed-Field Gradient Nuclear Magnetic Resonance as a Tool for Studying Translational Diffusion: Part 1. Basic Theory”, Concepts in Magnetic Resonance, vol. 9, Issue 5, pp. 299-336, 1997.
Non Patent Literature 3: H. Yasunaga et al., “Structures and Dynamics of Polymer Gel Systems Viewed Using NMR Spectroscopy”, Annual Reports on NMR Spectroscopy, vol. 34, pp. 39-104, 1997.
Non Patent Literature 4: Jacques G. H. Joosten et al., “Dynamic light scattering by nonergodic media: Brownian particles trapped in polyacrylamide gels”, Physical Review A, vol. 42, no. 4, pp. 2161-2175, 1990.
Non Patent Literature 5: V. Hagel et al., “Diffusion and interaction in PEG-DA hydrogels”, Biointerphases, vol. 8, no. 36, 2013.

### SUMMARY

### Technical Problem

FRAP is a method of performing fluorescence observation using a molecule having a fluorescent chromophore as a tracer molecule. In FRAP, first, a molecule having a fluorescently labeled site is uniformly diffused in hydrogel as a tracer molecule. Thereafter, a certain portion of the hydrogel is irradiated with a strong laser beam to quench fluorescence of the irradiated portion, and a change in fluorescence intensity after quenching is measured. As the diffusion of the tracer molecule in the hydrogel is faster, the fluorescence intensity at the above-described portion is recovered faster, so that the diffusion rate of molecules in the hydrogel can be estimated from the fluorescence recovery rate.

However, in FRAP, measurement can be performed only with a molecule having fluorescence, but the drug molecule does not necessarily have a fluorescent site, and the type of molecule capable of directly measuring the diffusion rate is limited. In addition, in a case where a fluorescently labeled drug molecule has been used for FRAP measurement, there is a difference in a molecular size or an interaction state with a hydrogel between the drug molecule fluorescently labeled and the drug molecule to be originally measured, which causes an error. In particular, in a case where the target drug is a small molecule, the molecular size of the fluorescently labeled site and the molecular size of the drug molecule are substantially the same. Therefore, when a fluorescently labeled site is provided (added), a significant molecular weight change occurs, and diffusion behavior is changed from the original target molecule.

PFG-NMR is a method in which a magnetic field having a gradient is applied to a substance to be measured for a certain period of time, and then a signal of a spin echo of a molecule is measured. In a case where the molecule to be measured diffuses in the hydrogel, the longer the time for applying the gradient magnetic field, the weaker the intensity of the observed spin echo signal. Since a molecule having a higher diffusion rate has a higher attenuation of the spin echo signal intensity with respect to the application time of the gradient magnetic field, the diffusion rate of the molecule to be measured can be estimated from the attenuation rate of the spin echo signal.

However, in PFG-NMR, a strong magnetic field is required in order to clearly observe a spin echo signal, and a large NMR device is required. PFG-NMR also requires a probe system for generating a magnetic field gradient. Since there is a limit to the application time of the magnetic field gradient, a larger magnetic field gradient must be generated when measuring slowly-diffusing molecules.

Dynamic light scattering is a method of measuring fluctuation in a refractive index caused by a polymer in a solution as a time change in scattered light intensity, and the speed of Brownian motion of the polymer can be known from the measurement result. However, since a low molecular weight tracer molecule such as a low molecular weight drug does not show refractive index fluctuation in a solution, the motion speed cannot be known by dynamic light scattering.

In addition, there is also a method of estimating the molecular mobility from a theoretical formula of diffusion by measuring elastic modulus of a gel and estimating mesh (network) size of the gel (Non Patent Literature 5). However, in the method of estimating the mesh size and the diffusion rate of molecules from the elastic modulus of the gel, the estimation result of the molecular diffusion rate varies depending on the difference in the diffusion theory to be used. Therefore, in order to use the gel as the coating material of DDS, it is necessary to actually measure the rate by experiment.

As described above, conventionally, there has been a problem that the diffusion rate in the hydrogel cannot be measured in a label-free manner without limiting the molecular size of the molecule to be measured.

The present invention has been made to solve the above problem, and an object of the present invention is to measure the diffusion rate in the hydrogel in a label-free manner without limiting the molecular size of the molecule to be measured.

### Solution to Problem

A molecular diffusion evaluation method according to embodiments of the present invention includes: a measurement step of transporting a solution in which a target molecule is dissolved into a channel including a measurement area by surface plasmon resonance and a hydrogel layer provided in the middle of the measurement area to obtain a first measurement result by surface plasmon resonance at a portion where the hydrogel layer is not formed in the measurement area and a second measurement result by surface plasmon resonance at a portion where the hydrogel layer is formed in the measurement area; and an evaluation step of evaluating a diffusion rate of molecules in the hydrogel by comparing the first measurement result with the second measurement result.

In addition, a molecular diffusion evaluation system according to embodiments of the present invention includes: a channel that includes a measurement area by surface plasmon resonance and a hydrogel layer provided in the middle of the measurement area and transports a solution in which a target molecule is dissolved; and a measurement device that performs a first measurement at a portion where the hydrogel layer is not formed in the measurement area and a second measurement at a portion where the hydrogel layer is formed in the measurement area by surface plasmon resonance.

### Advantageous Effects of Embodiments of the Invention

As described above, according to embodiments of the present invention, since the first measurement result by surface plasmon resonance at a portion where the hydrogel layer is not formed and the second measurement result by surface plasmon resonance at a portion where the hydrogel layer is formed in the measurement area are obtained, the diffusion rate in the hydrogel can be measured in a label-free manner without limiting the molecular size of the molecule to be measured.

### BRIEF DESCRIPTION OF THE DRAWINGS

FIG. 1 is a flowchart that illustrates a molecular diffusion evaluation method according to an embodiment of the present invention.

FIG. 2A is a configuration diagram illustrating a configuration of a molecular diffusion evaluation system according to an embodiment of the present invention.

FIG. 2B is a configuration diagram illustrating a configuration of a channel chip 100.

FIG. 2C is a plan diagram illustrating a partial configuration of the channel chip 100.

FIG. 2D is a perspective view illustrating a partial configuration of a measurement system.

FIG. 3 is a characteristic diagram illustrating a temporal change (a) of SPR signal at a first portion 201 and a temporal change (b) of SPR signal at a second portion 202.

FIG. 4 is a characteristic diagram illustrating a measurement result (a) at the first portion 201 and a measurement result (b) at the second portion 202 using a glucose solution as a measurement target.

FIG. 5 is a characteristic diagram illustrating a result of comparing SPR angle change curves when aqueous solutions of glucose [(a), (b)] and ethanol [(c), (d)] as tracer molecules are used as measurement targets.

### DETAILED DESCRIPTION OF ILLUSTRATIVE EMBODIMENTS

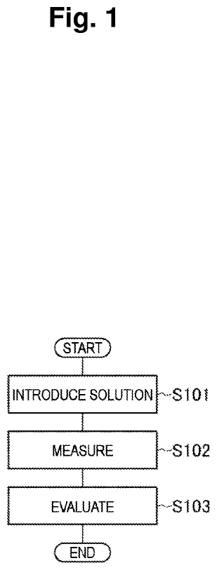

Hereinafter, a molecular diffusion evaluation method according to an embodiment of the present invention will be described with reference to FIG. 1. First, in step S101, a solution in which a target molecule (tracer molecule) is dissolved is introduced into a channel. The channel is formed on, for example, a measurement chip used by being attached to a surface plasmon resonance (SPR) measurement system. The channel includes a measurement area by surface plasmon resonance and a hydrogel layer provided in the middle of the measurement area.

Next, in step S102, the solution introduced into the channel is transported to obtain a first measurement result by surface plasmon resonance at a portion where the hydrogel layer is not formed in the measurement area and a second measurement result by surface plasmon resonance at a portion where the hydrogel layer is formed in the measurement area (measurement step). In a process where the solution in which the target molecule is dissolved passes through the portion where the hydrogel layer is not formed and the portion where the hydrogel layer is formed, the refractive index (SPR angle) at each portion is measured in time series, and the refractive index change (time change in SPR angle) at each portion is acquired. The refractive index change measured in the process of passing through the portion where the hydrogel layer is not formed is the first measurement result. In addition, the refractive index change measured in the process of passing through the portion where the hydrogel layer is formed is the second measurement result.

Next, in step S103, the diffusion rate of molecules in the hydrogel is evaluated by comparing the first measurement result with the second measurement result (evaluation step).

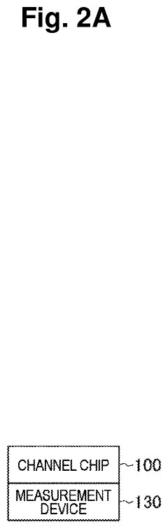

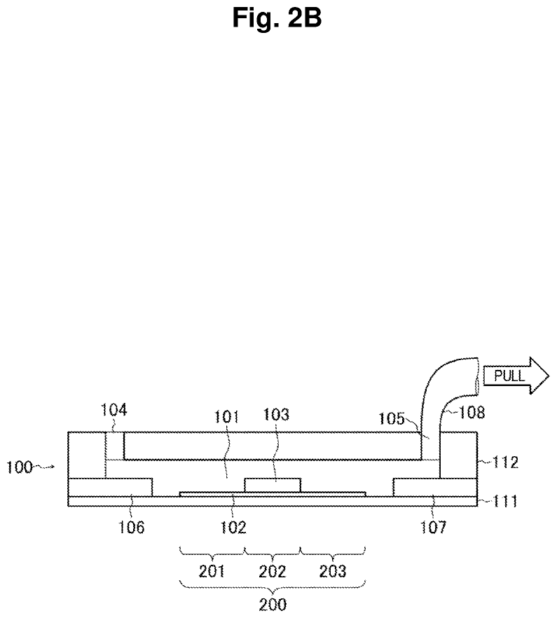

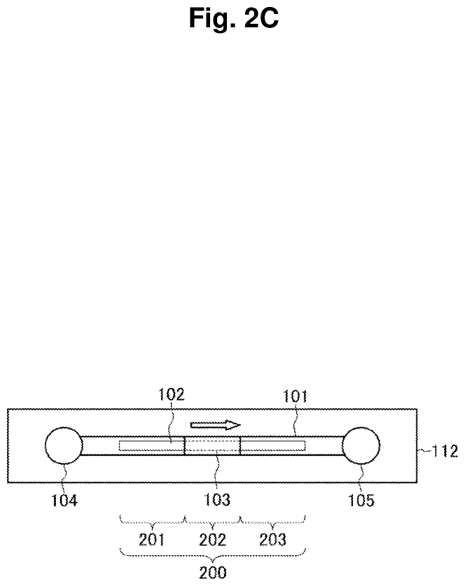

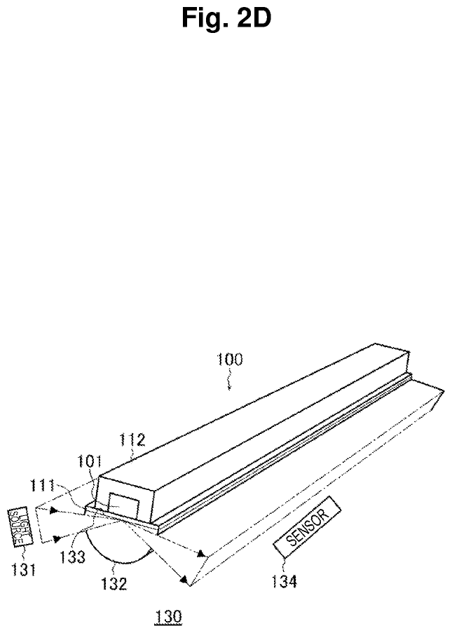

Next, a molecular diffusion evaluation system according to an embodiment of the present invention will be described with reference to FIGS. 2A, 2B, 2C, and 2D. The molecular diffusion evaluation system includes a channel chip 100 and a measurement device 130.

As illustrated in FIGS. 2B and 2C, the channel chip 100 includes a channel 101, a metal layer 102, and a hydrogel layer 103. The channel 101 includes an introduction port 104 and a discharge port 105. The solution in which the target molecule is dissolved is introduced from the introduction port 104 and transported through the channel 101. The channel 101 has a width of about 1.5 mm and a height of about 150 μm, for example. In addition, a portion where the hydrogel layer 103 is formed and the channel 101 near the introduction port 104 have a height of 70 μm.

For example, the channel chip 100 can be formed by bonding a glass substrate 111 to a channel substrate 112 including a groove portion to be the channel 101, the introduction port 104, and the discharge port 105. The channel substrate 112 can be formed, for example, by processing an acrylic plate.

The metal layer 102 is made of, for example, Au and has a thickness of about 50 nm. The metal layer 102 can be formed by, for example, a deposition technology such as sputtering. In the extending direction of the channel 101, an area where the metal layer 102 is formed is a measurement area 200 by surface plasmon resonance.

In addition, the hydrogel layer 103 is formed in the middle of the measurement area 200 of the channel 101. The hydrogel is, for example, an acrylamide gel. The hydrogel layer 103 can have, for example, a rectangular shape of 2 mm×1.5 mm in plan view and a thickness of 80 μm.

For example, with the use of a lift-off mask having an opening at a portion where the hydrogel layer 103 is formed, the lift-off mask is disposed at a predetermined portion of the glass substrate 111, a raw material of the hydrogel is applied, and a gelation reaction is performed by irradiating the raw material with ultraviolet rays to form the hydrogel. Thereafter, by removing (lift-off) the lift-off mask, the hydrogel layer 103 can be formed at a predetermined portion in the area to be the channel 101 of the glass substrate 111.

The hydrogel is not limited to an acrylamide gel as long as the hydrogel is physically or chemically adsorbed to the metal layer 102 and does not peel off from the metal layer during liquid feeding. The dimension (mesh size) of mesh and the swelling degree of the hydrogel are also not limited.

Here, the first portion 201 where the hydrogel layer 103 is not formed in the measurement area 200 is an area where the first measurement is performed. In addition, the second portion 202 where the hydrogel layer 103 is formed in the measurement area 200 is an area where the second measurement is performed. The first portion 201 is disposed on the introduction port 104 side as viewed from the second portion 202. A third portion 203 where the hydrogel layer 103 is not formed is also provided on the discharge port 105 side. The third portion 203 can be used for reference measurement.

At the third portion 203, an SPR measurement result equivalent to that at the first portion 201 is obtained except that the arrival time of the measurement solution is different. Therefore, for example, from the difference between the arrival time of the measurement solution at the first portion 201 and the arrival time of the measurement solution at the third portion 203, the arrival time of the measurement solution at the second portion 202 where the hydrogel is formed can be obtained. By correcting the time origin of the SPR angle change curve using the arrival time of the measurement solution at the second portion 202 obtained here, the time required for the tracer molecule to diffuse from the upper surface of the hydrogel layer 103 by the thickness of the hydrogel can be calculated.

In this example, a first spacer 106 and a second spacer 107 are provided on the bottom surface of the channel 101 on the glass substrate 111 side. The first spacer 106 is disposed immediately below the introduction port 104, and the second spacer 107 is disposed immediately below the discharge port 105. Also, the first spacer 106 and the second spacer 107 are disposed apart from the measurement area 200 in the extending direction of the channel 101. Moreover, a negative pressure pump 108 is connected to the discharge port 105, and the liquid in the channel 101 can be pulled (sucked) through the discharge port 105.

The thicknesses of the first spacer 106 and the second spacer 107 can be substantially the same as the thickness of the hydrogel layer 103 after being swollen by water. By reducing the cross-sectional area of the channel 101, measurement can be performed with a small amount of solution, but in this case, complicated operation is required for the negative pressure pump 108 for feeding liquid. Also, since the control of liquid feeding by the negative pressure pump 108 is also affected by a residual pressure in a pipe and the like, there is a time delay and the like, and the operation of the negative pressure pump 108 becomes complicated. In addition, when the height of the channel 101 is reduced without disposing the first spacer 106 and the second spacer 107, the height of the hydrogel after swelling reaches the upper wall surface of the channel 101 and blocks the channel 101, so that it is difficult to control liquid feeding using a pump.

On the other hand, by disposing the first spacer 106, it is possible to easily control feeding of a trace amount of liquid without requiring a complicated operation of the negative pressure pump 108, as described below. First, the negative pressure pump 108 is operated at a constant negative pressure having an absolute value smaller than the negative pressure acting on the liquid by a meniscus of the liquid introduced into the channel 101 formed in the introduction port 104 and having an absolute value larger than the negative pressure acting on the liquid by a meniscus of the liquid introduced into the introduction port 104.

Since the negative pressure by the negative pressure pump 108 is larger than the negative pressure generated by the meniscus of the liquid introduced into the introduction port 104, the liquid introduced into the introduction port 104 moves to the channel 101, and when the liquid introduced into the introduction port 104 flows out of the introduction port 104, the negative pressure generated by the meniscus of the liquid introduced into the channel 101 is larger than the negative pressure generated by the negative pressure pump 108, so that the movement of the liquid introduced into the channel 101 is stopped. As a result, it is possible to easily control feeding of a trace amount of liquid introduced into the channel 101 without delicately operating the negative pressure pump 108 (see JP 6133446 B2). In addition, by separating the positions of the first spacer 106 and the second spacer 107 from the measurement area 200 by 10 mm or more, it is possible to stably feed liquid without generating turbulence in the measurement area 200.

As illustrated in FIG. 2D, the measurement device 130 is an SPR device including a light source 131, a prism 132, and a sensor 134 including an imaging element such as a so-called CCD image sensor. Examples of the SPR device include “Smart SPR SS-100” manufactured by NTT Advanced Technology Corporation.

In the measurement device 130, a light emitted from the light source 131 is collected and incident on the prism 132, and the measurement area of the channel chip 100 in close contact with a measurement surface 133 of the prism 132 is irradiated with the light. The metal layer 102 is formed in the channel 101 that is the measurement area of the channel chip 100, and the back surface of the metal layer 102 is irradiated with the condensed light transmitted through the channel chip 100.

The condensed light irradiated in this manner is reflected by the back surface of the metal layer 102 with which the target solution is in contact, and is photoelectrically converted by the sensor 134 to obtain intensity (light intensity). A change in the refractive index (SPR angle change) is obtained by a change in the light intensity thus obtained.

In the measurement of the SPR angle, a change in the SPR angle when the solution passes through the first portion 201 and the second portion 202 is measured. The detection area of the sensor 134 corresponds to the first portion 201 and the second portion 202. In the detection area of the sensor 134, a plurality of photodiode elements are arranged side by side in the flow direction, and at the first portion 201 and the second portion 202, a change in light intensity (SPR angle) is measured for each position (pixel position) of each photodiode element. For example, photodiode elements of 480 pixels are arranged in a line at intervals of 10 μm at a portion corresponding to the measurement area 200 of the detection area of the sensor 134.

Assuming that the refractive index of the glass substrate 111 is n, the dielectric constant of the metal layer 102 is εm, the dielectric constant of the solution is εs, and the incident angle of light incident on the interface between the glass substrate 111 and the metal layer 102 is θ, resonance of plasmon induced at the incident angle and the interface between the glass substrate 111 and the metal layer 102 occurs under the condition that “n (ω/c) sine θ(ω/c) [εm×εs/(εm+εs)]^{1/2} . . . (1)” holds. This angle θ is the SPR angle.

Furthermore, when plasmon resonance occurs, reflected light is attenuated, and thus this state appears as a change in the detection value of any photodiode element of the sensor 134. Therefore, the SPR angle is obtained by the pixel position (pixel value) of the photodiode element in which the detection light intensity decreases, and as a result, the refractive index is obtained. For example, from the pixel value, the refractive index value is obtained by a conversion formula such as “refractive index value=pixel value×1.2739×10^{-4+1.3188} (light source wavelength: 770 nm)”.

The measurement device 130 performs the first measurement at the first portion 201 (the third portion 203) where the hydrogel layer is not formed in the measurement area 200 and the second measurement at the second portion 202 where the hydrogel layer is formed in the measurement area 200 by one feeding of the measurement solution by surface plasmon resonance. The evaluation of the diffusion rate of molecules in the hydrogel by the comparison between the first measurement result by the first measurement and the second measurement result by the second measurement by the measurement of the measurement device 130 can be performed using, for example, a computer device. The above-described evaluation can be performed by operating a predetermined program using a computer device.

The time change in the SPR angle obtained by the measurement by surface plasmon resonance at the first portion 201 where the hydrogel layer 103 is not formed in the measurement area 200 is defined as the first measurement result. In addition, the time change in the SPR angle obtained by the measurement by surface plasmon resonance at the second portion 202 where the hydrogel layer 103 is formed in the measurement area 200 is defined as the second measurement result.

In the molecular diffusion evaluation method using this molecular diffusion evaluation system, the area where the measurement by surface plasmon resonance (observation of SPR signal) can be performed is divided into two types of the first portion 201 (the third portion 203) and the second portion 202. First, at the first portion 201 where the hydrogel does not exist, the tracer molecule directly reaches the SPR observation area (area up to about 200 nm in height from the surface of the metal layer 102). The temporal change in the concentration of tracer molecules reaching the surface of the metal layer 102 conforms to “Taylor-dispersion”, and the temporal change in the SPR signal according to the dispersion of “Taylor dispersion” is observed.

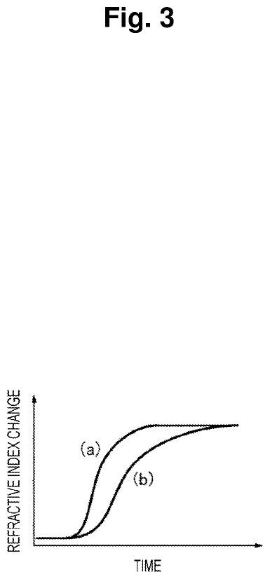

From the change in the SPR signal at the position of the first portion 201, (1) the timing when the measurement solution reaches the measurement area 200, (2) the influence of “Taylor dispersion” of tracer molecules in the measurement solution (diffusion rate of tracer molecules in the solvent), and (3) the maximum signal intensity of tracer molecules in the measurement solution can be determined. The temporal change of the SPR signal at the first portion 201 is measured as a reference curve [(a) of FIG. 3].

Next, at the second portion 202 where the hydrogel layer 103 is formed, the tracer molecule reaches the upper surface of the hydrogel layer 103, then diffuses downward in the hydrogel layer 103, and reaches the SPR observation area. By providing the first spacer 106 and the second spacer 107 having substantially the same height as the hydrogel layer 103, it can be considered that almost all tracer molecules are supplied from the upper surface of the hydrogel layer 103, are diffused in the hydrogel layer 103, and then reach the SPR observation area (area of about 200 nm from the surface of the metal layer 102).

In the measurement device 130, tracer molecules are also supplied from the surface of the gel parallel to the extending direction of the measurement area 200, which may affect the measurement result. However, it is designed so that the possibility of the above-described problematic state can be ignored by making the size of the hydrogel layer 103 sufficiently large such as 1.5 mm with respect to the gel thickness of 80 μm, and by bringing the surface of the gel parallel to the extending direction of the measurement area 200 into close contact with the spacer.

Since the tracer molecule diffuses in the hydrogel layer 103, the time until the tracer molecule reaches the SPR observation area is delayed as compared with the result at the first portion 201. This time delay represents the diffusion characteristics of tracer molecules in the hydrogel, and changes according to the mesh size of the hydrogel or the adsorption of the tracer molecules by chemical modification of the gel [(b) of FIG. 3].

Therefore, the diffusion characteristics of tracer molecules in the hydrogel can be evaluated by comparing the first measurement result with the second measurement result. For example, by determining a slope (differential coefficient) of each of the graph shown in (a) of FIG. 3 and the graph shown in (b) of FIG. 3 using a computer device, it is possible to evaluate the difference in the rate at which the tracer molecule diffuses in the solution and in the hydrogel layer 103. In addition, the time required for the tracer molecule to diffuse by the thickness of the hydrogel layer 103 can be obtained from the difference in the rising time of the SPR signal (time delay in paragraph 0048) between the graphs of (a) of FIG. 3 and (b) of FIG. 3. Since the first measurement result and the second measurement result are obtained in the same measurement, it is possible to simultaneously correct the influence of the concentration change of the solution during liquid feeding.

In the measurement data, the SPR angle obtained for each photodiode element (480 pixels) in the detection area of the sensor 134 at each measurement time is obtained as matrix data. The information on the diffusion of tracer molecules in each photodiode element (observation point) is observed as the change amount of the SPR angle and the temporal change thereof. Therefore, the SPR angle at each position when the channel 101 is filled with pure water before the measurement solution is introduced into the channel 101 is averaged with respect to the time axis, and a curve obtained by subtracting the average value as a baseline from the temporal change curve of the SPR angle is defined as the SPR angle change curve at each observation point.

Furthermore, in a case where the metal layer 102 is constituted of a gold layer formed by sputtering, the sensitivity and the baseline value slightly differ depending on the position of the metal layer 102, and thus, the SPR angle change curves of 10 adjacent observation points (100 μm in length) are averaged to reduce noise.

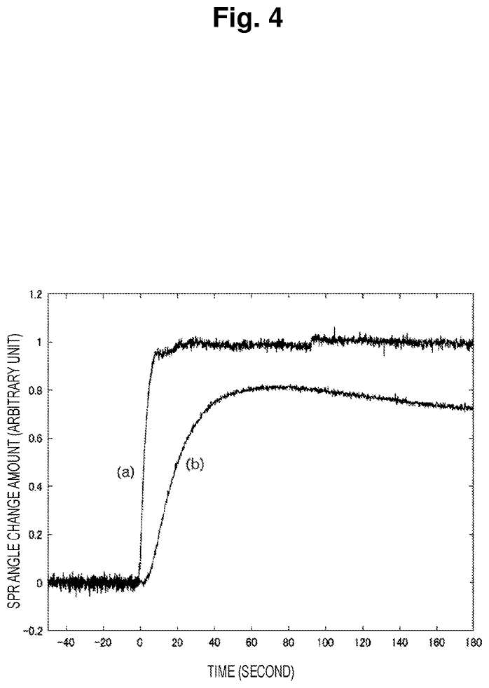

FIG. 4 illustrates an SPR angle change curve actually obtained by performing the above-described operation and analysis. FIG. 4 shows a measurement result (a) at the first portion 201 and a measurement result (b) at the second portion 202 when a glucose solution was flown. In the glucose solution, glucose is a tracer molecule. In the signal measured at the first portion 201 where the hydrogel layer 103 is not formed (first measurement result), the SPR angle rapidly changes with the introduction of the glucose solution, and immediately reaches a constant value.

On the other hand, at the second portion 202 where the hydrogel layer 103 is formed, the measured SPR angle (second measurement result) after the solution introduction changes more slowly than the result at the first portion 201. As described above, the difference between the diffusion of glucose molecules as tracer molecules in pure water at the first portion 201 and the diffusion rate of glucose molecules at the second portion 202 is observed as the difference in the slope of the SPR angle change curve. As described above, according to the embodiment, it has been demonstrated that the difference in diffusion rate can be compared.

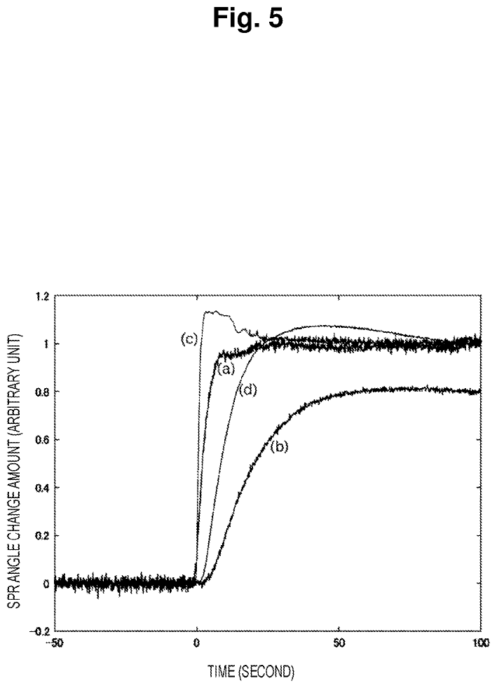

In addition, the measurement results for a plurality of tracer molecules are shown in FIG. 5. FIG. 5 is a comparison of SPR angle change curves when aqueous solutions of glucose [(a), (b)] and ethanol [(c), (d)] were flown as tracer molecules. In FIG. 5, (a) and (c) show the measurement result at the first portion 201 (first measurement result), and (b) and (d) show the measurement result at the second portion 202 (second measurement result).

In FIG. 5, each SPR angle change curve is linearly scaled such that the convergence values of the SPR angles in the first measurement results [(a) and (c)] become 1. By performing scaling processing, the diffusion rates of glucose and ethanol molecules diffusing in the solution and in the hydrogel layer 103 can be compared without being affected by the difference in refractive index (SPR angle change amount) between the aqueous glucose solution and the aqueous ethanol solution per unit molar concentration. As shown in FIG. 5, a state in which the diffusion rate in the acrylamide gel is different between glucose and ethanol is observed.

The SPR angle change amount after performing scaling processing correlates with the molar concentration of solute molecules in the solution and the hydrogel. On the other hand, a diffusion constant, which is a physical constant for comparing the diffusion rates of molecules, is defined as a time constant related to the change in concentration of tracer molecules with time [a/at (concentration of target molecules)]. Therefore, the SPR angle change curve after performing scaling processing can extract information on the diffusion coefficient of tracer molecules.

For example, when removing the signal of albumin that accounts for most of the polymer components in the blood as impurities for measurement, by controlling the conditions of the hydrogel to a mesh size of about 10 nm or less so that the mesh size of the hydrogel is smaller than the molecular size of albumin of 14 nm, the signal of the polymer that becomes impurities is removed, and the signal of diffusion of only the low molecular weight molecules can be measured.

As described above, according to the present invention, since the first measurement result by surface plasmon resonance at a portion where the hydrogel layer is not formed and the second measurement result by surface plasmon resonance at a portion where the hydrogel layer is formed in the measurement area are obtained, the diffusion rate in the hydrogel can be measured in a label-free manner without limiting the molecular size of the molecule to be measured.

Note that the present invention is not limited to the embodiments described above, and it is obvious that many modifications and combinations can be made by those skilled in the art within the technical idea of the present invention.

### REFERENCE SIGNS LIST

100 Channel chip
101 Channel
102 Metal layer
103 Hydrogel layer
104 Introduction port
105 Discharge port
106 First spacer
107 Second spacer
108 Negative pressure pump
111 Glass substrate
112 Channel substrate
130 Measurement device
131 Light source
132 Prism
133 Measurement surface
134 Sensor
200 Measurement area
201 First portion
202 Second portion
203 Third portion

The invention claimed is:

1-4. (canceled)

5. A method, comprising:
transporting a solution in which a target molecule is dissolved into a channel including a measurement area by surface plasmon resonance (SPR) and a hydrogel layer provided in the middle of the measurement area to obtain a first measurement result by surface plasmon resonance at a portion where the hydrogel layer is not formed in the measurement area and a second measurement result by surface plasmon resonance at a portion where the hydrogel layer is formed in the measurement area; and
evaluating a diffusion rate of the molecules in the hydrogel by comparing the first measurement result with the second measurement result.

6. The method according to claim 5, wherein a time change of an SPR angle obtained by measurement by surface plasmon resonance at a portion where the hydrogel layer is not formed in the measurement area is defined as the first measurement result, and a time change of an SPR angle obtained by measurement by surface plasmon resonance at a portion where the hydrogel layer is formed in the measurement area is defined as the second measurement result.

7. The method according to claim 5, wherein the target molecule is selected from the group consisting of small molecule drugs, biologics, and nucleic acid-based drugs.

8. The method according to claim 5, wherein the hydrogel is an acrylamide gel.

9. The method according to claim 5, wherein the solution is transported through the channel by a negative pressure pump.

10. The method according to claim 5, wherein the diffusion rate of molecules in the hydrogel is evaluated by comparing a slope of the first measurement result with a slope of the second measurement result.

11. The method according to claim 5, wherein the diffusion rate of molecules in the hydrogel is evaluated by comparing a time delay in a rising time of the first measurement result with a time delay in the rising time of the second measurement result.

12. The method according to claim 5, further comprising scaling the first measurement result and the second measurement result such that a convergence value of the first measurement result becomes 1.

13. A molecular diffusion evaluation system, comprising:
a channel that includes a measurement area by surface plasmon resonance and a hydrogel layer provided in the middle of the measurement area and configured to transport a solution in which a target molecule is dissolved; and
a measurement device configured to perform a first measurement at a portion where the hydrogel layer is not formed in the measurement area and a second measurement at a portion where the hydrogel layer is formed in the measurement area by surface plasmon resonance (SPR).

14. The molecular diffusion evaluation system according to claim 13, wherein the measurement device defines a time change of an SPR angle obtained by measurement by surface plasmon resonance at a portion where the hydrogel layer is not formed in the measurement area as the first measurement result by the first measurement, and a time change of an SPR angle obtained by measurement by surface plasmon resonance at a portion where the hydrogel layer is formed in the measurement area as the second measurement result by the second measurement.

15. A molecular diffusion evaluation system, comprising:
a channel chip including a channel, a metal layer, and a hydrogel layer, the channel including an introduction port and a discharge port, the metal layer being in the channel, and the hydrogel layer being in the middle of a measurement area of the channel; and
a measurement device including a light source, a prism, and a sensor, the light source configured to emit light that is collected and incident on the prism, the prism configured to irradiate the measurement area of the channel chip in close contact with a measurement surface of the prism with the light, and the sensor configured to photoelectrically convert the light reflected by a back surface of the metal layer with which a solution in which a target molecule is dissolved is in contact to obtain intensity.

16. The system of claim 15, wherein the hydrogel is an acrylamide gel.

17. The system of claim 15, wherein the sensor is configured to photoelectrically convert the light reflected by the back surface of the metal layer into an intensity measurement, the intensity measurement being indicative of a diffusion rate of the target molecule in the hydrogel layer.

18. The system of claim 16, wherein the channel chip further includes a first spacer and a second spacer, the first spacer and the second spacer being disposed on a bottom surface of the channel on a substrate side, and having substantially the same height as the hydrogel layer.

19. The system of claim 15, wherein the measurement device further includes a negative pressure pump connected to the discharge port of the channel, the negative pressure pump being configured to transport the solution through the channel.
